(19) United States
(12) Patent Application Publication
(10) Pub. No.: US 2024/0006682 A1
(43) Pub. Date: Jan. 4, 2024

(54) POWER STORAGE DEVICE AND ELECTRONIC DEVICE

(71) Applicant: SEMICONDUCTOR ENERGY LABORATORY CO., LTD., Atsugi-shi (JP)

(72) Inventors: Takeshi OSADA, Isehara (JP); Yosuke TSUKAMOTO, Atsugi (JP); Takayuki IKEDA, Atsugi (JP)

(21) Appl. No.: 18/342,001

(22) Filed: Jun. 27, 2023

(30) Foreign Application Priority Data
Jun. 29, 2022 (JP) 2022-104400

(51) Int. Cl. H01M 10/6554; H01M 10/0525; H01M 10/48

(52) U.S. Cl. CPC H01M 10/6554; H01M 10/0525; H01M 10/488

(57) ABSTRACT

A power storage device that can be discharged safely and easily is provided. The power storage device includes a secondary battery covered with an exterior body, a radiator plate in contact with a surface of the exterior body, and a projection. The projection has conductivity and is held over the exterior body in the normal condition. When the projection penetrates the exterior body to be inserted into the secondary battery, the secondary battery can be short-circuited and discharged. Heat can be efficiently released from the projection to the radiator plate. Thus, the secondary battery can be discharged safely at high speed without thermal runaway.

### BACKGROUND OF THE INVENTION

### 1. Field of the Invention

The invention disclosed in this specification and the like (hereinafter sometimes referred to as “the present invention” in this specification and the like) relates to a power storage device, a secondary battery, and the like. In particular, the present invention relates to a lithium ion battery.

The present invention relates to an object, a method, or a manufacturing method. The present invention relates to a process, a machine, manufacture, or a composition of matter. The present invention relates to a semiconductor device, a display device, a light-emitting device, a power storage device, a lighting device, an electronic device, a vehicle, or a manufacturing method thereof.

### 2. Description of the Related Art

Demand for lithium ion batteries has rapidly grown, for portable information terminals such as mobile phones, smartphones, and laptop computers; portable music players; digital cameras; medical equipment; hybrid vehicles (HVs); electric vehicles (EVs); and the like.

To collect a rare metal such as cobalt, recycling a used lithium ion battery is recommended. For example, Patent Document 1 discloses a battery processing method in which a lithium ion battery is discharged in liquid and then disassembled.

### REFERENCE

[Patent Document 1] Japanese Published Patent Application No. H11-97076

### SUMMARY OF THE INVENTION

A used lithium ion battery is recommended to be recycled as described above, but the used lithium ion battery is sometimes disposed together with an electronic device as an incombustible or the like without through a regular recycling process. A lithium ion battery sometimes causes ignition due to crushing treatment or the like, whereby waste plastics or the like might catch fire and fire might be caused in a waste disposal process.

In order to disassemble a lithium ion battery safely, it is necessary to sufficiently discharge the lithium ion battery. Patent Document 1 discloses a method for discharging the lithium ion battery safely by immersing the lithium ion battery in a conductive liquid. However, since most of the conductive liquid is acid or alkaline, a constituent material of a battery might be dissolved and a precipitate might be generated by discharging, for example. Thus, a cost for processing the used liquid, precipitate, or the like is caused. In addition, handling of a battery becomes complicated, e.g., drying is performed after discharging.

Accordingly, a lithium ion battery is desirably discharged safely and easily. The lithium ion battery does not theoretically cause ignition even when being crushed as long as it is discharged completely.

In view of the above problems, an object of one embodiment of the present invention is to provide a power storage device that can be discharged safely and easily. Another object is to provide a power storage device that can be discharged by a user. Another object is to provide an electronic device including the above-described power storage device.

One embodiment of the present invention relates to a power storage device having a discharging mechanism.

One embodiment of the present invention is a power storage device including a secondary battery, an exterior body, a radiator plate, and a projection. The secondary battery is covered with the exterior body. The radiator plate is provided so as to include a region in contact with the exterior body. The radiator plate includes a hole portion. The projection is provided in the hole portion.

As the secondary battery, a lithium ion battery can be used.

The radiator plate is preferably formed of a metal material.

The hole portion is preferably provided at the center of the radiator plate or the vicinity thereof in a top view.

The projection has a function of causing a short circuit between a positive electrode and a negative electrode of the secondary battery.

The projection is preferably of a screw type or a nail type and formed of a metal material.

An electronic device including the above power storage device is also one embodiment of the present invention.

According to one embodiment of the present invention, a power storage device that can be discharged safely and easily can be provided. A power storage device that can be discharged by a user can be provided. An electronic device including the above-described power storage device can be provided.

### BRIEF DESCRIPTION OF THE DRAWINGS

In the accompanying drawings:

FIG. 1 is a cross-sectional perspective view illustrating a power storage device;

FIG. 2A is a top view of the power storage device, and FIGS. 2B to 2E are cross-sectional views of the power storage device;

FIGS. 3A and 3B illustrate projections;

FIG. 4A is a cross-sectional view of the power storage device in the normal condition, and FIG. 4B is a cross-sectional view of the power storage device at the time of occurrence of a short circuit;

FIG. 5A is a cross-sectional view of the power storage device in the normal condition, and FIG. 5B is a cross-sectional view of the power storage device at the time of occurrence of a short circuit;

FIGS. 6A to 6D illustrate cross sections of the power storage device;

FIGS. 7A and 7B illustrate examples of a secondary battery, and FIG. 7C illustrates the internal state of the secondary battery;

FIGS. 8A to 8C illustrate an example of a secondary battery;

FIGS. 9A and 9B illustrate the appearances of a power storage device;

FIGS. 10A to 10C illustrate a method for fabricating a secondary battery;

FIGS. 11A to 11D illustrate examples of electronic devices; and

FIG. 12A illustrates examples of wearable devices, and FIGS. 12B and 12C illustrate a watch-type device.

### DETAILED DESCRIPTION OF THE INVENTION

Embodiments will be described in detail with reference to the drawings. Note that the present invention is not limited to the following description, and it will be readily appreciated by those skilled in the art that modes and details can be modified in various ways without departing from the spirit and scope of the present invention. Therefore, the present invention should not be construed as being limited to the description in the following embodiments.

Note that in the structures of the invention described below, the same portions or portions having similar functions are denoted by the same reference numerals in different drawings, and description of such portions is not repeated. The same hatching pattern is used for portions having similar functions, and the portions are not denoted by specific reference numerals in some cases.

The position, size, range, or the like of each structure illustrated in drawings is not accurately represented in some cases for easy understanding. Therefore, the disclosed invention is not necessarily limited to the position, size, range, or the like disclosed in the drawings.

In this specification and the like, the terms “electrode” and “wiring” do not limit the functions of the components. For example, an “electrode” is used as part of a “wiring” in some cases, and vice versa. Furthermore, the terms “electrode” and “wiring” also include the case where a plurality of “electrodes” and “wirings” are formed in an integrated manner, for example.

### Embodiment 1

In this embodiment, a power storage device of one embodiment of the present invention is described with reference to drawings.

One embodiment of the present invention is a power storage device that can be used as a power source of an electronic device and has a mechanism that facilitates discharging in disposal or the like. The power storage device includes a secondary battery covered with an exterior body, a radiator plate in contact with the exterior body, and a projection that can penetrate the exterior body.

The projection has conductivity and is held over the exterior body in the normal condition. When the projection penetrates the exterior body to be inserted into the secondary battery, the secondary battery can be short-circuited and discharged. In order to suppress the amount of heat generation due to the short circuit, the insertion depth of the projection into the secondary battery does not become deeper than required. Heat can be efficiently released from the projection to the radiator plate. Thus, the secondary battery can be discharged safely at high speed without thermal runaway.

Since a sufficiently discharged power storage device eliminates the need for a discharging operation in a recycling process, the process time for the recycling can be shortened and the cost can be reduced. Ignition does not occur in crushing treatment even if the power storage device is accidentally disposed as an incombustible or the like, so that fire can be prevented.

Note that the power storage device of one embodiment of the present invention includes a secondary battery capable of being charged and discharged, and is sometimes referred to as a battery pack or simply referred to as a battery in this specification.

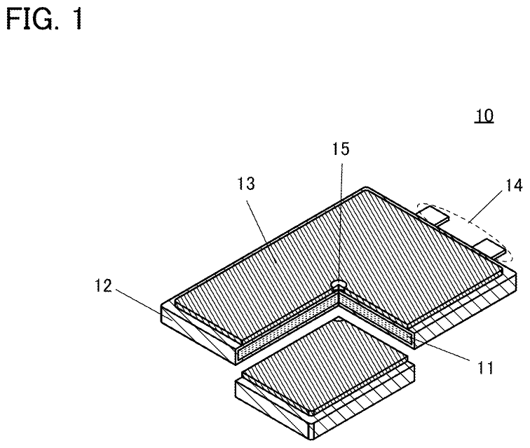

FIG. 1 is a cross-sectional perspective view of a battery pack, which is an example of the power storage device of one embodiment of the present invention, and part of which is cut off. A power storage device 10 includes a secondary battery 11, an exterior body 12, a radiator plate 13, electrode terminals 14, and a projection 15. Note that the secondary battery sometimes includes the exterior body as its component, but they are regarded as different components in this embodiment.

As the secondary battery 11, a laminated or wound lithium ion battery can be typically used. The secondary battery 11 includes a negative electrode, a positive electrode, a separator, an electrolyte solution, and the like which are covered with the exterior body 12. Note that one embodiment of the present invention can be applied to any battery in which heat generation and ignition due to an internal short circuit might be caused, such as a sodium ion battery or a potassium ion battery.

There is no particular limitation on a material of the exterior body 12. The exterior body 12 needs to be penetrated by an insertion operation of the projection 15 as described later, and thus is preferably formed of a material having lower mechanical strength than the projection 15. Since the projection 15 is appropriately formed of a hard metal material, a film-like or thin-plate resin having an appropriate thickness can be used for the exterior body 12, for example. A surface of the resin may be coated with a metal film or the like. Note that a region of the exterior body 12 except the region where the projection 15 is inserted may be formed of a material that does not easily allow the insertion of the projection 15.

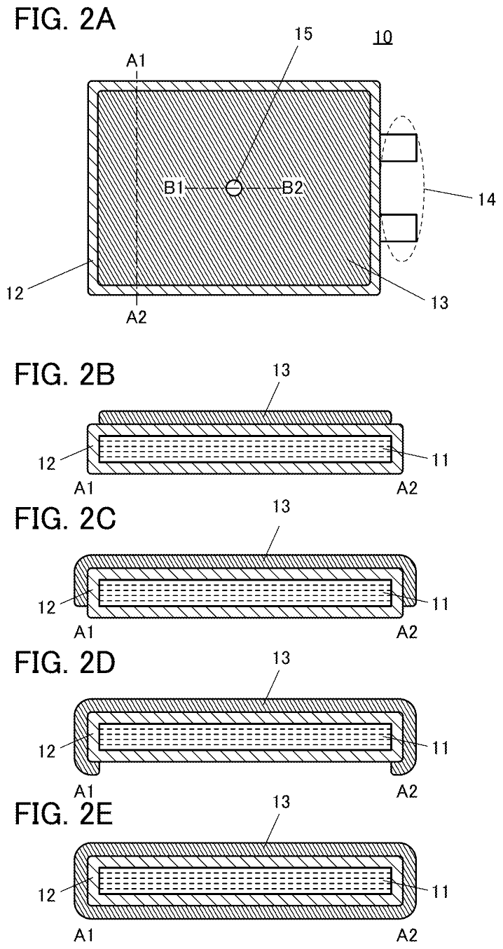

The radiator plate 13 is provided to include a region in contact with the exterior body 12. FIG. 2A is a top view of the power storage device 10, and FIGS. 2B to 2E are cross-sectional views taken along Al-A2 in FIG. 2A.

For example, when the exterior body 12 has a rectangular solid shape as illustrated in FIGS. 2A and 2B, the radiator plate 13 is preferably provided in contact with a first surface (top surface) of the rectangular solid. The radiator plate 13 may also be provided continuously from the first surface to second surfaces (side surfaces) as illustrated in FIG. 2C. The radiator plate 13 may also be provided continuously from the second surfaces to a third surface (bottom surface) as illustrated in FIG. 2D. The radiator plate 13 may also be provided to cover the exterior body 12 as illustrated in FIG. 2E. Any of these structures may be selected as appropriate in accordance with a mode of the electronic device using the power storage device 10.

In order to efficiently release heat generated when the secondary battery 11 is short-circuited, the radiator plate 13 is preferably formed as large as possible using a material having high thermal conductivity. The radiator plate 13 is preferably formed of a hard material having a good processability so that a screw hole or the like can be provided therein. Thus, it is appropriate that the radiator plate 13 is formed of a hard metal material having high thermal conductivity. For example, aluminum, copper, an alloy containing one or more of these, or the like can be used.

A mode of the electrode terminals 14 is not particularly limited. Although FIG. 1 illustrates an example in which lead electrode terminals are provided, the side surface or the surface opposite to the surface on which the radiator plate 13 is provided may be provided with the electrode terminals 14.

As illustrated in the top views of FIG. 1 and FIG. 2A, the projection 15 is preferably provided in a hole portion provided at the center of the radiator plate 13 or the vicinity thereof. Heat generated when the secondary battery 11 is short-circuited is conducted from the projection 15 to the radiator plate 13 to be released. When the projection 15 is provided in contact with the center of the radiator plate 13, heat can be conducted from the center of the radiator plate 13 to end portions thereof, so that the entire radiator plate 13 can be efficiency operated.

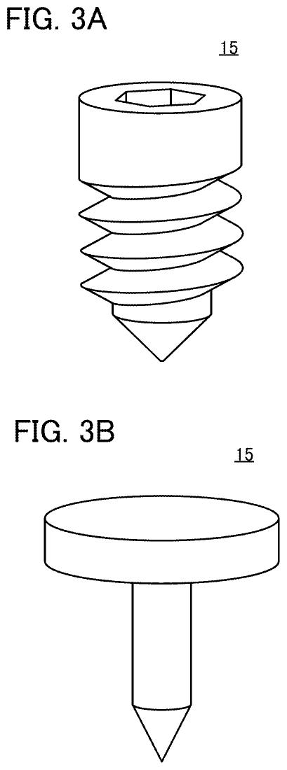

The projection 15 can have, for example, a screw type shape with a sharp tip portion as illustrated in FIG. 3A or a nail type shape with a sharp tip portion as illustrated in FIG. 3B. The projection 15 having any shape has conductivity to cause a short circuit in the secondary battery 11. Alternatively, the tip portion of the projection 15 and the vicinity thereof may have conductivity. The projection 15 is preferably formed of a material having high thermal conductivity so that heat generated when the secondary battery 11 is short-circuited is efficiently conducted from the projection 15 to the radiator plate 13.

Accordingly, it is appropriate that the projection 15 is formed of a metal material having high conductivity and high thermal conductivity. As such a material, the metal material used for the radiator plate 13 can be used. Alternatively, a hard metal material such as stainless steel (SUS) may be used so that the projection 15 can penetrate the exterior body 12 without much difficulty.

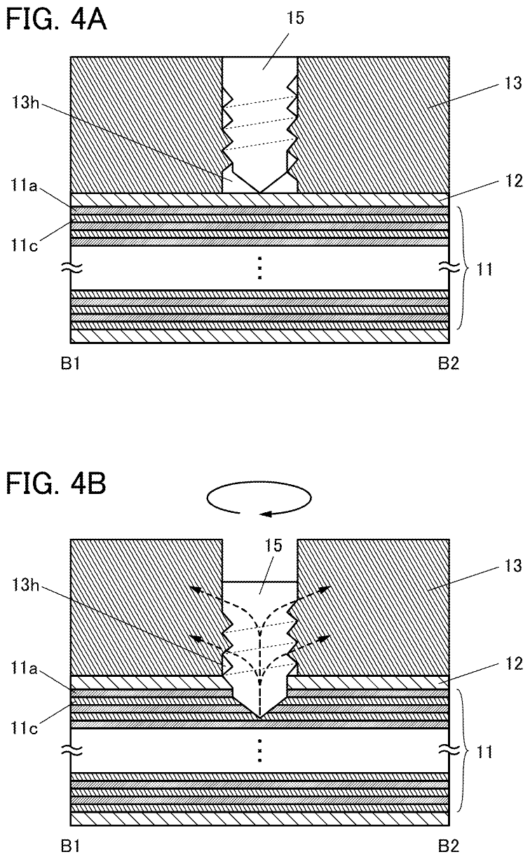

FIGS. 4A and 4B are cross-sectional views of the power storage device 10 and illustrate the case of using the screw type projection 15 illustrated in FIG. 3A. The cross-sectional views correspond to the cross section taken along B1-B2 in FIG. 2A. FIG. 4A illustrates the power storage device 10 in the normal condition, and FIG. 4B illustrates the power storage device 10 at the time of occurrence of a short circuit. Note that the normal condition means a period of a state before a short circuit operation is performed by the projection 15.

In the secondary battery 11 covered with the exterior body 12, positive electrodes 11a and negative electrodes 11c are alternately arranged. The radiator plate 13 is provided in contact with the exterior body 12, and the projection 15 is provided in a hole portion 13h (screw hole) included in the radiator plate 13. Note that oil, grease, an elastic adhesive, or the like may be provided in the hole portion 13h so that the projection is not easily fallen by vibration or the like.

In the normal condition, the level of the bottom edge (tip portion) of the projection 15 is higher than or equal to that of a top surface of the exterior body 12 (see FIG. 4A). When the projection 15 is rotated, the sharp tip portion penetrates the exterior body 12 and is inserted into the secondary battery 11, so that the secondary battery 11 can be short-circuited (see FIG. 4B).

Note that in FIGS. 4A and 4B, the hole portion 13h penetrates the radiator plate 13; however, the hole portion 13h may have a depressed shape whose bottom portion has a thin part of the radiator plate 13. In that case, when the projection 15 is rotated, the sharp tip portion penetrates the part of the radiator plate 13 and the exterior body 12 and is inserted into the secondary battery 11.

It is preferable that the total length of the projection 15 be equal to the total length of the hole portion 13h, or be shorter than the total length of the hole portion 13h in a range where the tip portion of the projection 15 can be inserted into the secondary battery 11. In the normal condition, the level of the upper edge of the projection 15 is preferably lower than or equal to that of a top surface of the radiator plate 13. When the level of the upper edge of the projection 15 is higher than that of the top surface of the radiator plate 13 in the normal condition, the projection 15 might be in contact with an unspecified object and be rotated, leading to a short circuit in the secondary battery 11.

The projection 15 is preferably of a set screw type. The radiator plate 13 has higher heat dissipation as the thickness is larger; however, increasing the thickness of the radiator plate 13 increases the volume and the weight of the whole power storage device.

Assuming power storage devices having the same charge and discharge capacity, a smaller and lighter weight one is desired to the other.

Accordingly, even when the radiator plate 13 does not have an enough thickness, it is preferable that the projection 15 be easily held and rotated. In particular, the projection 15 is preferably of a hollow type such as a hexagon socket set screw. When the hollow type projection 15 is used, a region into which a tool is inserted can be sufficiently secured even though the total length of the projection 15 is short.

A screw part (screw thread and screw groove) of the hole portion 13h, which is a female screw, is provided in a region near the exterior body 12. A screw part of the projection 15, which is a male screw, is not provided in a region near the upper edge. With such a structure, as illustrated in FIG. 4B, the region near the upper edge of the projection 15 functions as a stopper, which can prevent an insertion depth of the projection 15 into the secondary battery 11 from being deeper than necessary.

In the secondary battery 11 described as an example in this embodiment, positive electrodes and negative electrodes are alternately arranged in the thickness direction regardless of a structure such as a laminated structure or a wound structure. In such a structure, for example, when a nail is stuck and the positive electrodes and the negative electrodes are short-circuited through the nail, a relatively large amount of current flows to the nail and Joule heat is generated due to the resistance of the nail. The generated heat is conducted from the nail to the components of the secondary battery 11, and when the temperature of the components reaches higher than or equal to a certain temperature, positive electrodes, negative electrodes, or an electrolyte solution ignites.

In one embodiment of the present invention, the positive electrode 11a and the negative electrode 11c are intentionally short-circuited through the projection 15 for discharging; however, the temperature increase and ignition are suppressed by limiting the current amount when a short circuit occurs and releasing heat efficiently. The mechanism is described below.

Inserting the projection 15 into the secondary battery 11 can cause a short circuit. At this time, the number of regions to be short-circuited is as small as possible in the secondary battery 11 (see FIG. 4B). For example, the total number of regions, which are in contact with the projection 15, of the positive electrodes 11a and the negative electrodes 11c is greater than or equal to 2 and less than or equal to 10, preferably greater than or equal to 2 and less than or equal to 6, further preferably greater than or equal to 2 and less than or equal to 4. In order to reduce the number of regions to be short-circuited as described above, the positions where the screw parts of the radiator plate 13 and the projection 15 are provided are adjusted so that the stopper functions at an appropriate insertion depth of the projection 15.

The number of regions where the positive electrodes and the negative electrodes are short-circuited is reduced as described above, whereby current flowing to the projection 15 per unit time can be reduced. According to the Joule heating formula Q[J]=RI²t (R: resistance [Ω], I: current [A], and t: time [s]), it is found that as current is lowered, the amount of heat to be generated is lowered. In addition, by reducing the numbers of short-circuit portions and heat generating portions, the total amount of generated heat can be suppressed.

The radiator plate 13 is provided over the exterior body 12 as described above, so that heat can be efficiently released. As shown by dashed line arrows in FIG. 4B, heat generated in the vicinity of the bottom edge (tip portion) of the projection 15 is conducted throughout the projection 15 and then conducted to the radiator plate 13 in contact with the projection 15. Thus, the temperature of the secondary battery 11 can be inhibited from rising higher than or equal to a certain temperature, whereby the secondary battery 11 can be discharged without igniting.

When the projection 15 is of a screw type, an exclusive tool (e.g., hexagonal wrench) is required, so that a user can short-circuit the power storage device with a clear intention of disposing. In other words, the power storage device can be inhibited from being accidentally short-circuited by the user.

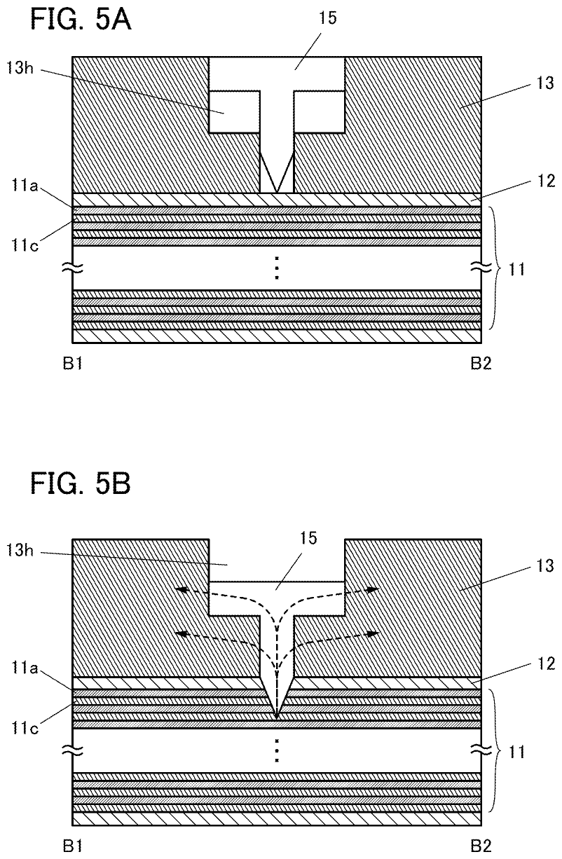

FIGS. 5A and 5B are cross-sectional views of the power storage device 10 in the case of using the nail type projection 15 illustrated in FIG. 3B. The cross-sectional views correspond to the cross section taken along B1-B2 in FIG. 2A. FIG. 5A illustrates the power storage device 10 in the normal condition, and FIG. 5B illustrates the power storage device 10 at the time of occurrence of a short circuit. Note that description that is common to FIGS. 4A and 4B is omitted.

A head portion of the projection 15 preferably has a relatively wide surface area. As the contact area between the head portion of the projection 15 and the radiator plate 13 is larger, heat can be released more efficiently. For example, the projection 15 can include a disk-shaped head portion and a column portion having a sharp end. Note that the head portion and the column portion may be integrally formed

As illustrated in FIG. 5A, the hole portion 13h into which the head portion and the column portion can be inserted is formed in the radiator plate 13. With the hole portion 13h having such a shape, the head portion of the projection 15 functions as a stopper. Thus, the insertion depth of the projection 15 into the secondary battery 11 can be controlled.

The projection 15 is held in the hole portion 13h provided in the radiator plate 13. In the normal condition, the level of the bottom edge (tip portion) of the projection is higher than or equal to that of the top surface of the exterior body 12 (see FIG. 5A). When the head portion of the projection 15 is pressed, the sharp tip portion penetrates the exterior body 12 and is inserted into the secondary battery 11, so that the secondary battery 11 can be short-circuited (see FIG. 5B).

It is preferable that the total length of the projection 15 be equal to the total length of the hole portion 13h, or be shorter than the total length of the hole portion 13h in a range where the tip portion of the projection 15 can be inserted into the secondary battery 11. In the normal condition, the level of the upper edge of the projection 15 is preferably lower than or equal to that of the top surface of the radiator plate 13. When the level of the upper edge of the projection 15 is higher than that of the top surface of the radiator plate 13 in the normal condition, the projection 15 might be in contact with an unspecified object and be pressed, leading to a short circuit in the secondary battery 11.

When the projection 15 is pressed from above, the secondary battery 11 can be short-circuited. As shown by dashed line arrows in FIG. 5B, heat generated in the vicinity of the bottom edge (tip portion) of the nail type projection 15 is conducted throughout the projection 15 and then conducted to the radiator plate 13 in contact with the projection 15. Thus, the temperature of the secondary battery 11 can be inhibited from rising higher than or equal to a certain temperature, whereby the secondary battery 11 can be discharged without igniting.

In the case where the projection 15 is of a nail type, the power storage device can be short-circuited with the use of a common tool (e.g., pen tip). Since a short circuit can be caused with a tool other than an exclusive tool, a short-circuit work can be performed easily in disposal.

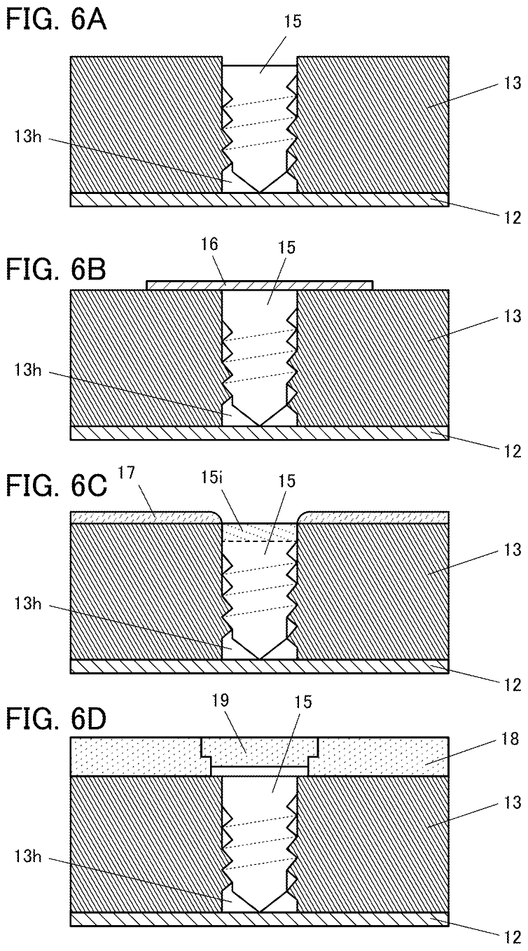

Note that as described above, in the normal condition, the level of the upper edge of the projection 15 may be lower than that of the top surface of the radiator plate 13 as illustrated in FIG. 6A. As illustrated in FIG. 6B, a protection sticker 16 may be provided over the projection 15 and the radiator plate 13 to cover the hole portion 13h. By peeling or breaking the protection sticker 16, the upper edge of the projection 15 can be exposed. With the structures illustrated in FIGS. 6A and 6B, the projection 15 can be prevented from being accidentally subjected to a rotated operation.

As illustrated in FIG. 6C, an insulating region 15i may be provided in the vicinity of the upper edge of the projection 15. The insulating region 15i can be provided by, for example, forming the head portion of the projection 15 using a resin. An insulating layer 17 may be provided over the radiator plate 13. Examples of the insulating layer 17 include insulating paint and an insulating film. With the structure illustrated in FIG. 6C, electric shock can be prevented when the voltage of a battery is high.

The power storage device 10 is incorporated in a housing of an electronic device and cannot be detached easily in some cases. In the electronic device with such a structure, it is preferable that a hole portion be provided in a region of a housing 18 overlapping with the projection 15 and the vicinity thereof and a detachable lid 19 be provided in the hole portion as illustrated in FIG. 6D. This structure enables discharging to be performed by a short circuit in the power storage device 10 even when the power storage device 10 cannot be detached easily.

Note that although FIGS. 6A to 6D illustrate the screw type projection 15 as examples, the nail type projection 15 can also be used. In addition, the structures in FIGS. 6A to 6D can be combined freely.

According to one embodiment of the present invention described above, when the electronic device is unnecessary or the battery is unnecessary with battery change, a user can discharge the battery by safe and simple work to dispose (recycle) the electronic device or the battery as resources. Accordingly, a complicated discharging operation in a recycling process is unnecessary, so that the recycling cost can be reduced. Even when the electronic device or the battery is disposed without through a regular recycling process, ignition due to crushing is not caused; thus, fire can be prevented.

Note that a power storage device that is discharged using one embodiment of the present invention is in a short-circuited state, whereby the voltage decreases to almost V. Thus, a protection circuit in a charger detects the short-circuited state of the power storage device even when a charging operation is accidentally performed, so that charging is not performed, and safety can be ensured.

The structures, methods, and the like described in this embodiment can be combined as appropriate with any of the structures, methods, and the like described in the other embodiments.

### Embodiment 2

In this embodiment, components of a lithium ion battery that can be used as a secondary battery included in the power storage device of one embodiment of the present invention will be described.

The lithium ion battery includes a negative electrode, a positive electrode, an electrolyte, a separator, and an exterior body.

### [Negative Electrode]

The negative electrode includes a negative electrode active material layer and a negative electrode current collector. The negative electrode active material layer contains a negative electrode active material and may further contain a conductive material and a binder.

For example, metal foil can be used for a current collector. The negative electrode can be formed by applying slurry onto metal foil and drying the slurry. Note that pressing may be performed after drying. The negative electrode is a component obtained by forming an active material layer over the current collector.

Slurry refers to a material solution that is used to form an active material layer over the current collector and contains an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Negative Electrode Active Material>

As the negative electrode active material, for example, a carbon material or an alloy-based material can be used.

As the carbon material, for example, graphite (natural graphite or artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium ion battery using graphite can have a high operating voltage. In addition, graphite is preferable because of its advantages such as a relatively high capacity per unit volume, relatively small volume expansion, low cost, and higher level of safety than that of a lithium metal.

Non-graphitizing carbon can be obtained by baking a synthetic resin such as a phenol resin, and an organic substance of plant origin, for example. In non-graphitizing carbon contained in the negative electrode active material of the lithium ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

For the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferable that x be 1 or have an approximate value of 1. For example, x is preferably 0.2 or more and 1.5 or less, further preferably 0.3 or more and 1.2 or less.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high discharge capacity (900 mAh/g and 1890 mAh/cm 3).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind or a combination of various kinds of the negative electrode active materials described above can be used. For example, a combination of a carbon material and silicon or a combination of a carbon material and silicon monoxide can be used.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charge of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

When the negative electrode that does not contain a negative electrode active material is used, a film may be included over a negative electrode current collector for uniforming lithium deposition. For the film for uniforming lithium deposition, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over a negative electrode current collector relatively easily, and thus is preferable as the film for uniforming lithium deposition. Moreover, as the film for uniforming lithium deposition, for example, a metal film that forms an alloy with lithium can be used. As the metal film that forms an alloy with lithium, for example, a magnesium metal film can be used. Lithium and magnesium form a solid solution in a wide range of compositions, and thus are suitable for the film for uniforming lithium deposition.

When the negative electrode that does not contain a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferable that the passivation film can conduct lithium ions while suppressing electrical conduction.

### <Conductive Material>

A conductive material is also referred to as a conductivity-imparting agent and a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as a positive electrode active material layer or a negative electrode active material layer preferably contains a conductive material.

As the conductive material, for example, one or more kinds of carbon black such as acetylene black or furnace black, graphite such as artificial graphite or natural graphite, carbon fiber such as carbon nanofiber or carbon nanotube, and a graphene compound can be used.

Examples of the carbon fiber include mesophase pitch-based carbon fiber and isotropic pitch-based carbon fiber. As the carbon fiber, carbon nanofiber, carbon nanotube, or the like can be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

The active material layer may contain, as a conductive material, metal powder or metal fiber of copper, nickel, aluminum, silver, gold, or the like, a conductive ceramic material, or the like.

The content of the conductive material to the total amount of the active material layer is preferably greater than or equal to 1 wt % and less than or equal to 10 wt %, further preferably greater than or equal to 1 wt % and less than or equal to 5 wt %. Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A compound containing particulate carbon such as carbon black or graphite or a compound containing fibrous carbon such as carbon nanotube easily enters a microscopic space. A microscopic space refers to, for example, a region between a plurality of active materials. When a carbon-containing compound that easily enters a microscopic space and a compound containing sheet-like carbon, such as graphene, that can impart conductivity to a plurality of particles are used in combination, the density of the electrode increases and an excellent conductive path can be formed. The battery obtained by the fabrication method of one embodiment of the present invention can have high capacitive density per volume and stability, and is effective as an in-vehicle battery.

### <Current Collector>

For a current collector, it is possible to use a material which has high conductivity and is not alloyed with carrier ions of lithium or the like, e.g., a metal such as stainless steel, gold, platinum, zinc, iron, copper, aluminum, or titanium, an alloy thereof, or the like. The current collector can have a sheet-like shape, a net-like shape, a punching-metal shape, an expanded-metal shape, or the like as appropriate.

A resin current collector can be used as the current collector. As the resin current collector, for example, a resin current collector including a resin such as polyolefin (e.g., polypropylene or polyethylene), nylon (polyamide), polyimide, vinylon, polyester, acrylic, or polyurethane, and a particulate or fibrous conductive material (also referred to as a conductive filler) can be used.

As the conductive material contained in the resin current collector, a conductive carbon material and one or more of metal materials such as aluminum, titanium, stainless steel, gold, platinum, zinc, iron, and copper can be used. As the conductive carbon material, for example, one or more kinds of carbon black such as acetylene black or furnace black, graphite such as artificial graphite or natural graphite, carbon fiber such as carbon nanofiber or carbon nanotube, graphene, and a graphene compound can be used. Note that in the case where the resin current collector is used as a positive electrode current collector, an antioxidant such as a hindered phenol-based material is further preferably used.

Examples of the carbon fiber include mesophase pitch-based carbon fiber and isotropic pitch-based carbon fiber. As the carbon fiber, carbon nanofiber, carbon nanotube, or the like can be used. Carbon nanotube can be formed by, for example, a vapor deposition method.

Note that the average particle diameter of the conductive materials contained in the resin current collector can be greater than or equal to 10 nm and less than or equal to lam, and is preferably greater than or equal to 30 nm and less than or equal to 5 μm.

The current collector preferably has a thickness greater than or equal to 5 μm and less than or equal to 30 lam.

Note that a material that is not alloyed with carrier ions of lithium or the like is preferably used for the negative electrode current collector.

### [Positive Electrode]

The positive electrode includes a positive electrode active material layer and a positive electrode current collector. The positive electrode active material layer contains a positive electrode active material and may further contain at least one of a conductive material and a binder. Note that the positive electrode current collector, the conductive material, and the binder described in [Negative electrode] can be used. For example, metal foil can be used for the current collector. The positive electrode can be formed by applying slurry onto metal foil and drying the slurry. Note that pressing may be performed after drying. The positive electrode is a component obtained by forming an active material layer over the current collector.

Slurry refers to a material solution that is used to form an active material layer over the current collector and contains an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

As the positive electrode active material, any one or more of a composite oxide having a layered rock-salt structure, a composite oxide having an olivine structure, and a composite oxide having a spinel structure can be used.

As the composite oxide having a layered rock-salt structure, any one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM/O₂ (M1 is one or more selected from nickel, cobalt, manganese, and aluminum), and a coefficient of the composition formula is not limited to an integer.

As the lithium cobalt oxide, for example, lithium cobalt oxide to which magnesium and fluorine are added can be used. Lithium cobalt oxide to which magnesium, fluorine, aluminum, and nickel are added is preferably used.

As the lithium nickel-cobalt-manganese oxide, for example, lithium nickel-cobalt-manganese oxide with a ratio such as nickel:cobalt:manganese=1:1:1, 6:2:2, 8:1:1, 9:0.5:0.5 can be used. As the above lithium nickel-cobalt-manganese oxide, for example, lithium nickel-cobalt-manganese oxide to which any one or more of aluminum, calcium, barium, strontium, and gallium are added is preferably used.

As the composite oxide having an olivine structure, any one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Alternatively, a composite oxide having a spinel structure such as LiMn₂O₄ can be used.

### [Electrolyte]

Examples of the electrolyte are described below. As one mode of the electrolyte, a liquid electrolyte (also referred to as an electrolyte solution) containing a solvent and an electrolyte dissolved in the solvent can be used. The electrolyte is not limited to a liquid electrolyte (electrolyte solution) that is liquid at room temperature, and a solid electrolyte can be used as well. Alternatively, an electrolyte including both the liquid electrolyte that is liquid at room temperature and the solid electrolyte that is a solid at room temperature (such an electrolyte is referred to as a semi-solid electrolyte) can also be used. Note that when the solid electrolyte or the semi-solid electrolyte is used for a bendable battery, part of a stack in the battery includes the electrolyte, whereby the battery can maintain the flexibility.

In the case of using the liquid electrolyte for a secondary battery, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these can be used in an appropriate combination at an appropriate ratio, for example.

Alternatively, the use of one or more ionic liquids (room temperature molten salts) that are less likely to burn and volatize as the solvent of the electrolyte can prevent a secondary battery from exploding or igniting even when the secondary battery causes an internal short circuit or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where a lithium ion is used as a carrier ion, for example, an electrolyte contains lithium salt. As the lithium salt, for example, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), or LiN(C₂F₅SO₂)₂ can be used.

For example, an organic solvent described in this embodiment includes ethylene carbonate (EC), ethyl methyl carbonate (EMC), and dimethyl carbonate (DMC). When a total content of the ethylene carbonate, the ethyl methyl carbonate, and the dimethyl carbonate is set to 100 vol %, an organic solvent in which the volume ratio of ethylene carbonate to ethyl methyl carbonate and dimethyl carbonate is x:y:100-x-y (where 5≤x≤35 and 0<y<65) can be used. More specifically, an organic solvent containing EC, EMC, and DMC at EC:EMC:DMC=30:35:35 in a volume ratio can be used.

The electrolyte solution is preferably highly purified and contains a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

In order to form a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

When a high-molecular material that can gel is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

When the electrolyte includes an electrolyte solution, the separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

The exterior body included in the secondary battery can be formed of a resin material. For example, a film type resin formed of polyethylene, polypropylene, polycarbonate, ionomer, polyamide, or the like can be used. Alternatively, it is possible to use a film having a three-layer structure in which a highly flexible metal thin film of aluminum, stainless steel, copper, nickel, or the like is provided over these film type resins, and an insulating synthetic resin film of a polyamide-based resin, a polyester-based resin, or the like is provided over the metal thin film as the outer surface of the exterior body. Note that the exterior body is sometimes referred to as a housing.

The structures, methods, and the like described in this embodiment can be combined as appropriate with any of the structures, methods, and the like described in the other embodiments.

### Embodiment 3

In this embodiment, an example of a mode of a secondary battery that can be used in one embodiment of the present invention will be described.

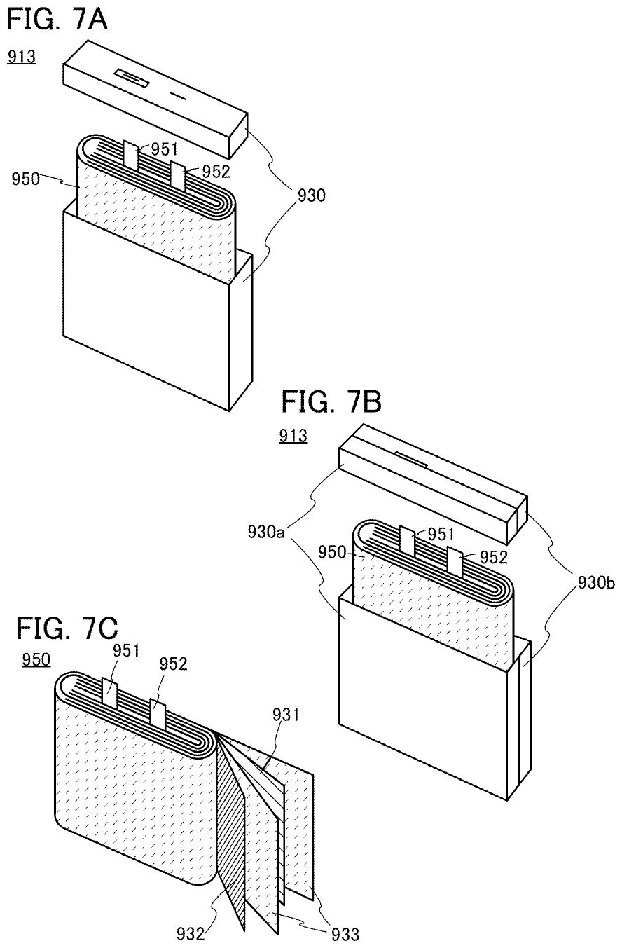

A secondary battery 913 illustrated in FIG. 7A includes a wound body 950 provided with an electrode terminal 951 and an electrode terminal 952 inside an exterior body 930. The wound body 950 is immersed in an electrolyte solution inside the exterior body 930. The electrode terminal 952 is in contact with the exterior body 930. The use of an insulator or the like inhibits contact between the electrode terminal 951 and the exterior body 930. Note that in FIG. 7A, the exterior body 930 divided into pieces is illustrated for convenience; however, in the actual structure, the wound body 950 is covered with the exterior body 930 and the electrode terminal 951 and the electrode terminal 952 extend to the outside of the exterior body 930. For the exterior body 930, a resin material can be used.

Note that as illustrated in FIG. 7B, the exterior body 930 in FIG. 7A may be formed using a plurality of materials. For example, in the secondary battery 913 illustrated in FIG. 7B, an exterior body 930a and an exterior body 930b are bonded to each other, and the wound body 950 is provided in a region surrounded by the exterior body 930a and the exterior body 930b.

FIG. 7C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

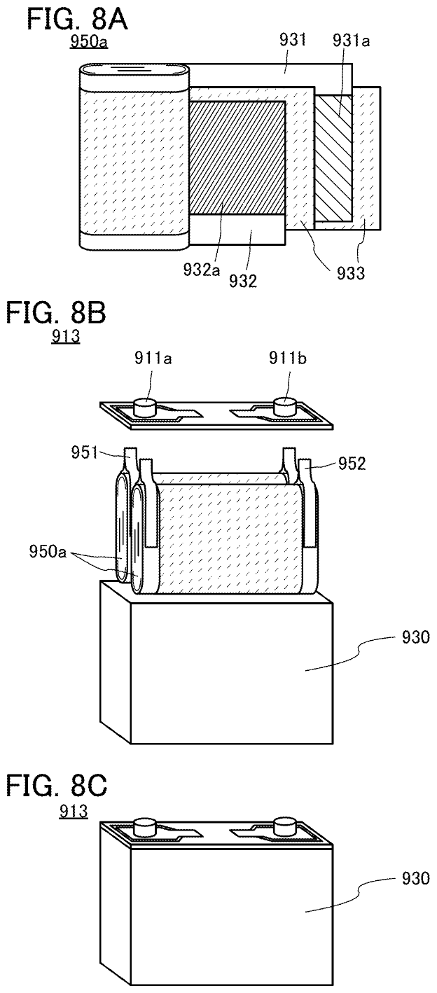

The secondary battery 913 may include a wound body 950a as illustrated in FIG. 8A. The wound body 950a illustrated in FIG. 8A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 8B, the negative electrode 931 is electrically connected to the electrode terminal 951 by ultrasonic bonding, welding, or pressure bonding. The electrode terminal 951 is electrically connected to a terminal 911a. The positive electrode 932 is electrically connected to the electrode terminal 952 by ultrasonic bonding, welding, or pressure bonding. The electrode terminal 952 is electrically connected to a terminal 911b.

As illustrated in FIG. 8C, the wound body 950a and an electrolyte solution are covered with the exterior body 930, whereby the secondary battery 913 is completed. The exterior body 930 is preferably provided with a safety valve, an overcurrent protection element, and the like. In order to prevent the battery from exploding, a safety valve is a valve to be released when the internal pressure of the exterior body 930 reaches a predetermined pressure.

As illustrated in FIG. 8B, the secondary battery 913 may include a plurality of wound bodies 950a. The use of the plurality of wound bodies 950a enables the secondary battery 913 to have higher discharge capacity. The description of the secondary battery 913 illustrated in FIGS. 7A to 7C can be referred to for the other components of the secondary battery 913 illustrated in FIGS. 8A and 8B.

### <Laminated Power Storage Device>

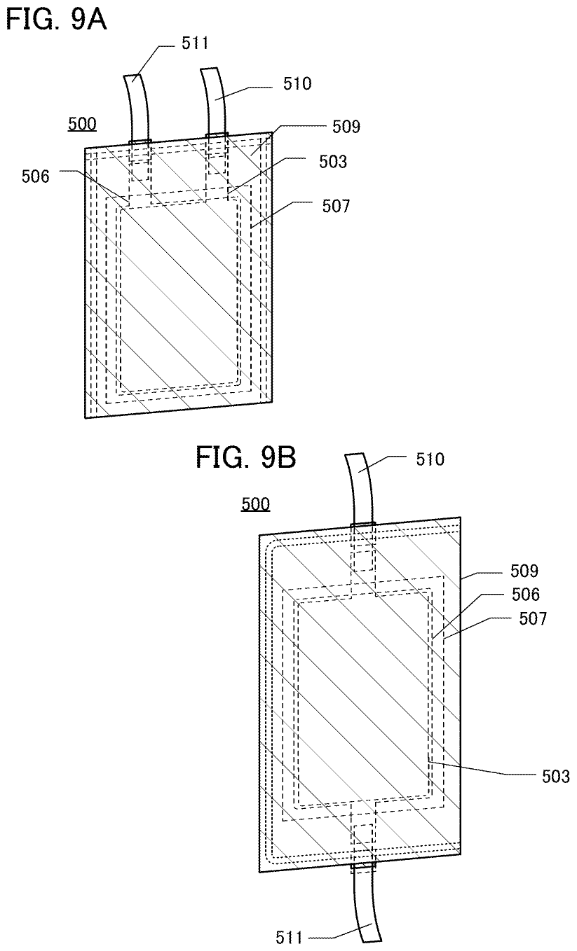

Next, examples of the appearance of a laminated power storage device are illustrated in FIGS. 9A and 9B. FIGS. 9A and 9B each illustrate a positive electrode 503, a negative electrode 506, a separator 507, an exterior body 509, a positive electrode lead electrode 510, and a negative electrode lead electrode 511. A portion of the positive electrode lead electrode 510 that is exposed to the outside of the power storage device can be referred to as a positive electrode terminal, and a portion of the negative electrode lead electrode 511 that is exposed to the outside of the power storage device can be referred to as a negative electrode terminal.

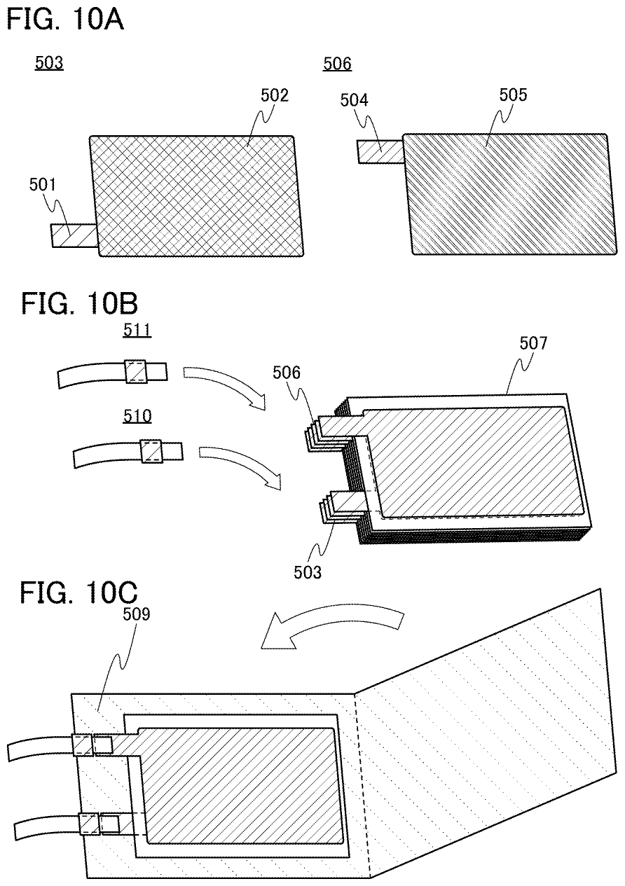

FIG. 10A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those illustrated in FIG. 10A.

### <Method for Fabricating Laminated Power Storage Device>

An example of a method for fabricating the laminated power storage device having the appearance illustrated in FIG. 9A will be described with reference to FIGS. and 10C.

First, the negative electrode 506, the separator 507, and the positive electrode 503 are stacked. FIG. 10B illustrates the negative electrodes 506, the separators 507, and the positive electrodes 503 that are stacked. The power storage device described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 10C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated power storage device 500 can be fabricated.

The structures, methods, and the like described in this embodiment can be combined as appropriate with any of the structures, methods, and the like described in the other embodiments.

### Embodiment 4

In this embodiment, examples of an electronic device in which the power storage device of one embodiment of the present invention is mounted will be described. Examples of the electronic device including the power storage device include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

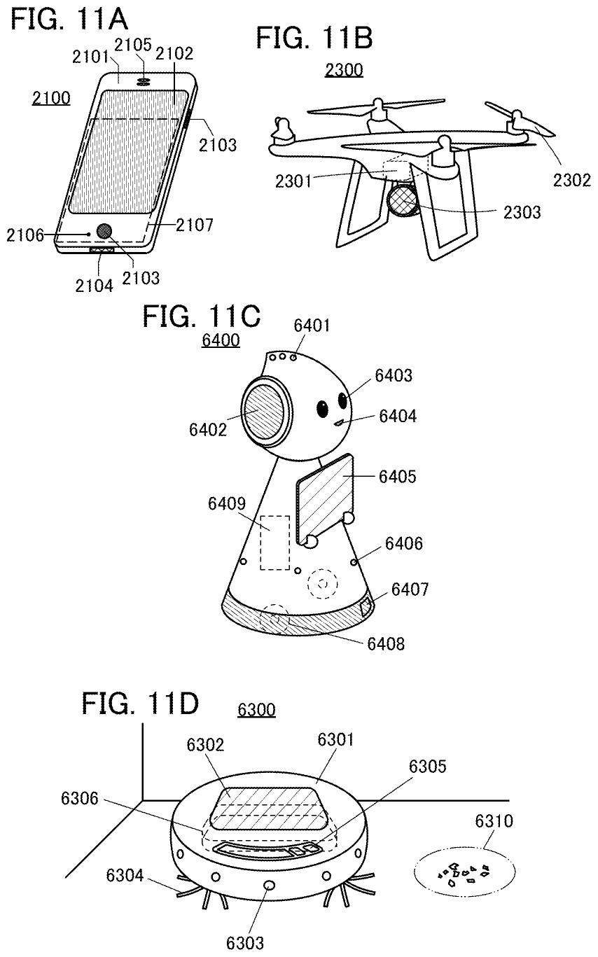

FIG. 11A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a power storage device 2107.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 11B illustrates an unmanned aircraft 2300 including a plurality of rotors 2302. The unmanned aircraft 2300 is also referred to as a drone. The unmanned aircraft 2300 includes a power storage device 2301 of one embodiment of the present invention, a camera 2303, and an antenna (not illustrated). The unmanned aircraft 2300 can be remotely controlled through the antenna.

FIG. 11C illustrates an example of a robot. A robot 6400 illustrated in FIG. 11C includes a power storage device 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like. The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the power storage device 6409 of one embodiment of the present invention and a semiconductor device or an electronic component.

FIG. 11D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a power storage device 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the power storage device 6306 of one embodiment of the present invention and a semiconductor device or an electronic component.

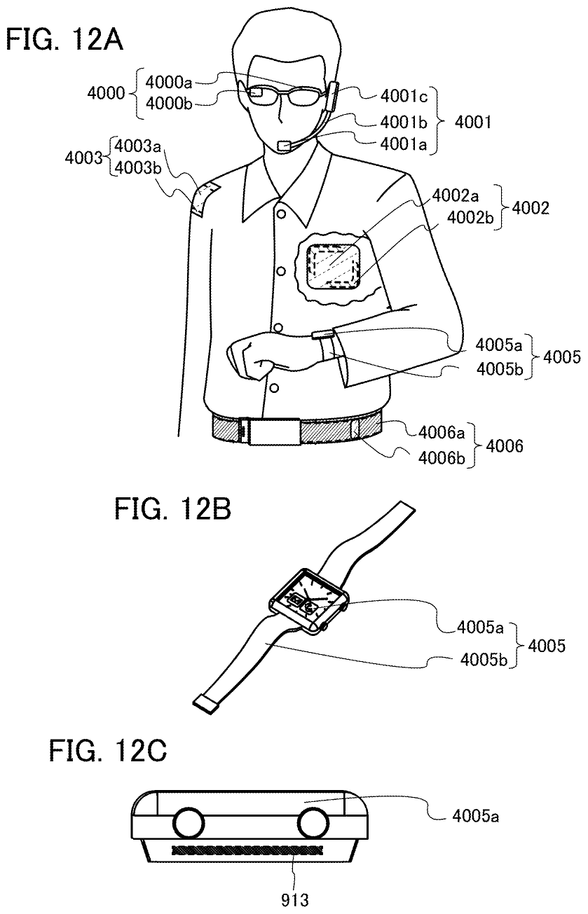

FIG. 12A illustrates examples of wearable devices. A power storage device is used as a power source of a wearable device. To have improved splash resistance, water resistance, or dust resistance in daily use or outdoor use by a user, a wearable device is desirably capable of being charged with and without a wire whose connector portion for connection is exposed.

For example, the power storage device of one embodiment of the present invention can be provided in a glasses-type device 4000 illustrated in FIG. 12A. The glasses-type device 4000 includes a frame 4000a and a display portion 4000b. The power storage device is provided in a temple of the frame 4000a having a curved shape, whereby the glasses-type device 4000 can be lightweight, can have a well-balanced weight, and can be used continuously for a long time.

The power storage device of one embodiment of the present invention can be provided in a headset-type device 4001. The headset-type device 4001 includes at least a microphone part 4001a, a flexible pipe 4001b, and an earphone portion 4001c. The power storage device can be provided in the flexible pipe 4001b or the earphone portion 4001c.

The power storage device of one embodiment of the present invention can be provided in a device 4002 that can be attached directly to a body. A power storage device 4002b can be provided in a thin housing 4002a of the device 4002.

The power storage device of one embodiment of the present invention can be provided in a device 4003 that can be attached to clothes. A power storage device 4003b can be provided in a thin housing 4003a of the device 4003.

The power storage device of one embodiment of the present invention can be provided in a belt-type device 4006. The belt-type device 4006 includes a belt portion 4006a and a wireless power feeding and receiving portion 4006b, and the power storage device can be provided in the inner region of the belt portion 4006a.

The power storage device of one embodiment of the present invention can be provided in a watch-type device 4005. The watch-type device 4005 includes a display portion 4005a and a belt portion 4005b, and the power storage device can be provided in the display portion 4005a or the belt portion 4005b.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 12B is a perspective view of the watch-type device 4005 that is detached from an arm.

FIG. 12C is a side view. FIG. 12C illustrates a state where the secondary battery 913 is incorporated in the inner region. The secondary battery 913 is provided to overlap the display portion 4005a, can have a high density and high capacity, and is small and lightweight.

The structures, methods, and the like described in this embodiment can be combined as appropriate with any of the structures, methods, and the like described in the other embodiments.

This application is based on Japanese Patent Application Serial No. 2022-104400 filed with Japan Patent Office on Jun. 29, 2022, the entire contents of which are hereby incorporated by reference.

What is claimed is:

1. A power storage device comprising:
a secondary battery;
an exterior body;
a radiator plate; and
a projection,
wherein the secondary battery is covered with the exterior body,
wherein the radiator plate is provided so as to comprise a region in contact with the exterior body,
wherein the radiator plate comprises a hole portion, and
wherein the projection is provided in the hole portion.

2. The power storage device according to claim 1, wherein the secondary battery is a lithium ion battery.

3. The power storage device according to claim 1, wherein the radiator plate is formed of a metal material.

4. The power storage device according to claim 1, wherein the hole portion is provided at a center or a vicinity of the center of the radiator plate in a top view.

5. The power storage device according to claim 1, wherein the projection is configured to cause a short circuit between a positive electrode and a negative electrode of the secondary battery.

6. The power storage device according to claim 5, wherein the projection is of a screw type and formed of a metal material.

7. The power storage device according to claim 5, wherein the projection is of a nail type and formed of a metal material.

8. An electronic device comprising:
the power storage device according to claim 1; and
a display portion.
